(19) United States
(12) Patent Application Publication
(10) Pub. No.: US 2019/0124909 A1
(43) Pub. Date: May 2, 2019

(54) WEED GROWTH SUPPRESSION DEVICE

(71) Applicant: Sandy Schaller, Allentown, PA (US)

(72) Inventor: Sandy Schaller, Allentown, PA (US)

(21) Appl. No.: 15/794,862

(22) Filed: Oct. 26, 2017

(51) Int. Cl. A01M 21/02; A01G 1/08

(52) U.S. Cl. CPC A01M 21/02; A01G 1/08

(57) ABSTRACT

A weed growth suppression device, including a first spike assembly to be inserted at least partially into a surface, a second spike assembly to be inserted at least partially into the surface, and a rod to connect the first spike assembly to the second spike assembly.

### BACKGROUND OF THE INVENTION

### 1. Field of the Invention

The present general inventive concept relates generally to a weed growth suppression device.

### 2. Description of the Related Art

It is well known that weeds are a nuisance in outdoor gardens, as they sprout through grass in random locations, and compete with plants for space, nutrients and sunlight, causing other plants and vegetation to potentially wilt and die.

Therefore, there is a need for a device that suppresses the growth of weeds, thereby preventing weeds from harming other more favorable plants and vegetation.

### SUMMARY

The present general inventive concept provides a weed growth suppression device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a weed growth suppression device, including a first spike assembly to be inserted at least partially into a surface, a second spike assembly to be inserted at least partially into the surface, and a rod to connect the first spike assembly to the second spike assembly.

The first spike assembly may include a first spike, including a first tapered portion disposed at a first end of the first spike, such that the first end of the first spike is insertable into the surface, and a first ribbed extension disposed at and extending away from a second end of the first spike, a first disc, including a first center hole to receive the first ribbed extension, and a first plurality of holes disposed at circumferential edges of the first disc to receive a first end of the rod, and a first securing mechanism to secure the first disc onto the first spike at the second end.

The second spike may include a second spike, including a second tapered portion disposed at a first end of the second spike, such that the first end of the second spike is insertable into the surface, and a second ribbed extension disposed at and extending away from a second end of the second spike, a second disc, including a second center hole to receive the second ribbed extension, and a second plurality of holes disposed at circumferential edges of the second disc to receive a second end of the rod, and a second securing mechanism to secure the second disc onto the second spike at the second end.

The first end and the second end of the rod may each be curved to secure the rod between the first disc and the second disc.

The first securing mechanism may include a nut to screw onto the first ribbed extension in a direction toward the disc, and a washer disposed on the first ribbed extension between the nut and the disc.

The spike assembly may further include at least one angled protrusion to extend diagonally upwards and away from a surface of the spike.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a weed growth suppression device, according to an exemplary embodiment of the present general inventive concept; and

FIG. 2 illustrates an exploded view of a spike assembly, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

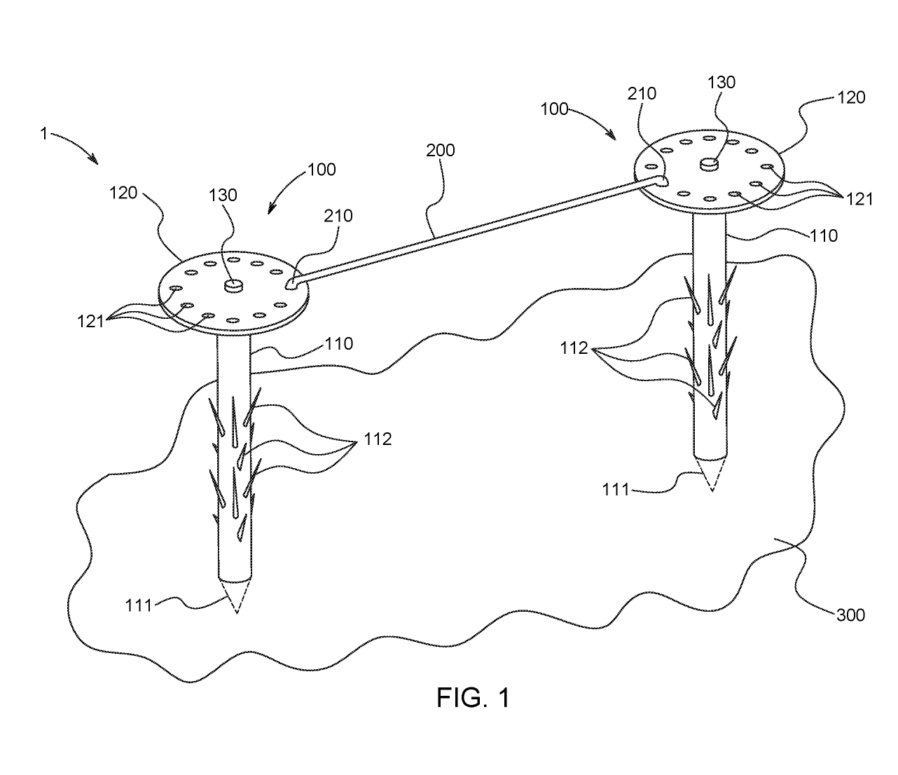

FIG. 1 illustrates a weed growth suppression device 1, according to an exemplary embodiment of the present general inventive concept.

All portions of the weed growth suppression device 1 may have various sizes, shapes, and colors, and may be made from metal, wood, plastic, ceramic, rubber, or any other type of material known to one of ordinary skill in the art.

Referring to FIG. 1, the weed growth suppression device 1 may include a plurality of spike assemblies 100 and a rod 200.

The plurality of spike assemblies 100 may each include a spike 110, a disc 120, and a securing mechanism 130.

The spike 110 may include a tapered portion 111 disposed at a bottom portion of the spike 110, and at least one angled protrusion 112 extending away from a surface of the spike 110.

The tapered portion 111 may facilitate insertion of the spike 110 into a surface 300 (e.g., soil, grass, or any other relatively soft surface).

The at least one angled protrusion 112 may extend diagonally upwards and away from a surface of the spike 110. The at least one angled protrusion 112 may be included to prevent the spike 110 from being extracted from the surface 300.

The disc 120 may include a plurality of holes 121 disposed at circumferential edges of the disc 120.

The securing device 130 may allow the disc 120 to be secured to the spike 110.

The rod 200 may include curved end portions 210.

The curved end portions 210 of the rod may be inserted into holes 121 of the discs 121. Accordingly, the rod 200 may act to prevent and/or suppress growth of weeds.

The holes 121 are preferably provided in plurality in order to allow a user to optionally place multiple spikes assemblies 100 around a plant, for example, in order to encapsulate the plant between a plurality of rods 200, thereby preventing/suppressing weeds from growing around the plant.

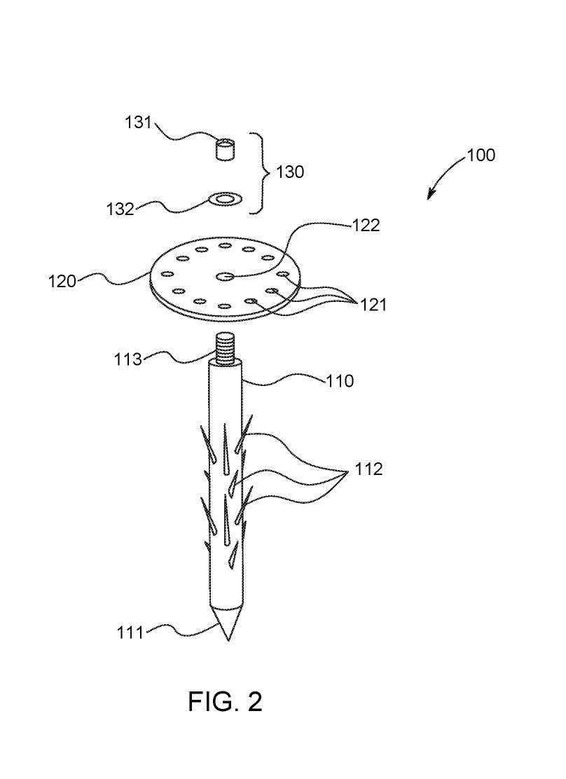

FIG. 2 illustrates an exploded view of the spike assembly 100, according to an exemplary embodiment of the present general inventive concept.

Referring to FIG. 2, the spike assembly 100 may include a spike 110, a disc 120, and a securing mechanism 130.

The spike 110 may include a tapered portion 111 disposed at a bottom portion of the spike 110, at least one angled protrusion 112 extending away from a surface of the spike 110, and a ribbed extension 113 extending away from a top portion of the spike 110.

The tapered portion 111 may facilitate insertion of the spike 110 into a surface 300 (e.g., soil, grass, or any other relatively soft surface).

The at least one angled protrusion 112 may extend diagonally upwards and away from a surface of the spike 110. The at least one angled protrusion 112 may be included to prevent the spike 110 from being extracted from the surface 300.

The disc 120 may include a plurality of holes 121 disposed at circumferential edges of the disc 120, and a center hole 122.

The securing mechanism 130 may include a nut 131 and a washer 132.

The securing mechanism 130 may allow the disc 120 to be secured to the spike 110. More specifically, the ribbed extension 113 may be inserted first through the center hole 122 of the disc 120, followed by the nut 132, followed by the nut 131 screwing onto the ribbed extension 113. As such, the securing mechanism 130 secures the disc 120 to the spike 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A weed growth suppression device, comprising:
a first spike assembly to be inserted at least partially into a surface;
a second spike assembly to be inserted at least partially into the surface; and
a rod to connect the first spike assembly to the second spike assembly.

2. The weed growth suppression device of claim 1, wherein the first spike assembly comprises:
a first spike, comprising:
a first tapered portion disposed at a first end of the first spike, such that the first end of the first spike is insertable into the surface, and
a first ribbed extension disposed at and extending away from a second end of the first spike;
a first disc, comprising:
a first center hole to receive the first ribbed extension, and
a first plurality of holes disposed at circumferential edges of the first disc to receive a first end of the rod; and
a first securing mechanism to secure the first disc onto the first spike at the second end.

3. The weed growth suppression device of claim 2, wherein the second spike assembly comprises:
a second spike, comprising:
a second tapered portion disposed at a first end of the second spike, such that the first end of the second spike is insertable into the surface, and
a second ribbed extension disposed at and extending away from a second end of the second spike;
a second disc, comprising:
a second center hole to receive the second ribbed extension, and
a second plurality of holes disposed at circumferential edges of the second disc to receive a second end of the rod; and
a second securing mechanism to secure the second disc onto the second spike at the second end.

4. The weed growth suppression device of claim 1, wherein the first end and the second end of the rod are each curved to secure the rod between the first disc and the second disc.

5. The weed growth suppression device of claim 2, wherein the first securing mechanism comprises:
a nut to screw onto the first ribbed extension in a direction toward the disc; and
a washer disposed on the first ribbed extension between the nut and the disc.

6. The weed growth suppression device of claim 1, wherein the spike assembly further comprises at least one angled protrusion to extend diagonally upwards and away from a surface of the spike.
